(19) United States
(12) Patent Application Publication
(10) Pub. No.: US 2012/0331380 A1
(43) Pub. Date: Dec. 27, 2012

(54) SYSTEM FOR PREPARING AND MANAGING SERVICE MANUAL, AND METHOD AND RECORD MEDIUM FOR PREPARING OR MANAGING SERVICE MANUAL

(75) Inventor: HITOMI OHANA, Tokyo (JP)

(73) Assignee: Olympus Corporation, Tokyo (JP)

(21) Appl. No.: 13/489,698

(22) Filed: Jun. 6, 2012

(30) Foreign Application Priority Data
Jun. 21, 2011 (JP) 2011-137205

(51) Int. Cl. G06F 17/00

(52) U.S. Cl. 715/255

(57) ABSTRACT

The present invention discloses a method for preparing a service manual using a computer, the service manual being used for maintenance or repair of a product on the basis of production work information that has been prepared, including production information and an assembling procedure of the product, the method comprising: extracting, on the basis of association information which associates the manufacturing information with service information required for maintenance or repair of the product, the service information which corresponds to the production work information; preparing the service manual using the production work information and the service information corresponding to said production work information and extracted by the service information extracting unit; and registering at least the association information of a new item of the service manual edited via an operation performed by a user at the time of preparing the service manual.

### CROSS-REFERENCE TO RELATED APPLICATIONS

This application claims benefit of Japanese Application No. 2011-137205, filed on Jun. 21, 2011, the contents of which are incorporated by this reference.

### BACKGROUND OF THE INVENTION

1. Field of the Invention

The present invention relates to a preparing and managing system, a preparing method, a record medium for preparing programs, a managing method, and a record medium for a managing program, for a service manual used for maintenance and repair services.

2. Description of the Related Art

Conventionally, a technique has been proposed which can automatically prepare either the assembling procedure or the disassembling procedure of an electronic device when the other is prepared, and can quickly and easily refer to the assembling procedure sheet and the disassembling procedure sheet (for example, see Patent Document 1).

Patent Document 1: Japanese Laid-open Patent Publication No. 2007-7740

### SUMMARY OF THE INVENTION

The present invention discloses a service manual preparing and managing system for preparing and managing a service manual used for maintenance or repair of a product on the basis of production work information that has been prepared, including manufacturing information and an assembling procedure of the product, the service manual preparing and managing system including: an association information storing unit which stores association information associating the manufacturing information with service information required for maintenance or repair of the product; a service information extracting unit which extracts the service information corresponding to the production work information on the basis of the association information; a service manual preparing and editing unit which prepares the service manual as well as edits said service manual using the production work information and the service information corresponding to said production work information and extracted by the service information extracting unit; a new item editing unit which edits a new item of the service manual via an operation performed by a user at the time of preparing and renewing the service manual; and a new item registering unit which registers at least the association information of the new item edited by the new item editing unit in the association information storing unit.

The present invention discloses a method for preparing a service manual using a computer, the service manual being used for maintenance or repair of a product on the basis of production work information that has been prepared, including production information and an assembling procedure of the product, the method including: extracting, on the basis of association information which associates the manufacturing information with service information required for maintenance or repair of the product, the service information which corresponds to the production work information, using the computer; preparing the service manual using the production work information and the service information corresponding to said production work information and extracted by the service information extracting unit, using the computer; and registering at least the association information of a new item of the service manual edited via an operation performed by a user at the time of preparing the service manual using the computer.

The present invention discloses A record medium storing a service manual preparing program for causing a computer to execute a process for preparing a service manual used for maintenance or repair of a product on the basis of production work information that has been prepared, including manufacturing information and an assembling procedure of the product, the process including: extracting, on the basis of association information which associates the manufacturing information with service information required for maintenance or repair of the product, the service information which corresponds to the production work information; preparing the service manual using the production work information and the service information which corresponds to the production work information and is extracted by the service information extracting unit; and registering at least the association information of a new item of the service manual edited via an operation performed by a user at the time of preparing the service manual.

The present invention discloses a method for managing a service manual using a computer, the service manual being used for maintenance or repair of a product on the basis of production work information that has been prepared, including production information and an assembling procedure of the product, the method including; registering at least the association information of a new item of the service manual edited via an operation performed by a user at the time of renewing the service manual using the computer.

The present invention discloses a record medium storing a service manual managing program for causing a computer to execute a process for managing a service manual used for maintenance or repair of a product on the basis of production work information that has been prepared, including manufacturing information and an assembling procedure of the product, the process including registering at least the association information of a new item of the service manual edited via an operation performed by a user at the time of renewing the service manual.

### BRIEF DESCRIPTION OF THE DRAWINGS

FIG. 1 is a skeleton framework illustrating a service manual preparing and managing system according to one embodiment of the present invention.

FIG. 2 is a skeleton framework illustrating an example of the computer which is applicable to one embodiment of the present invention.

FIG. 3 is a flow chart illustrating a general flow according to one embodiment of the present invention.

FIG. 4 is a flow chart illustrating a preparation process of production drawing information according to one embodiment of the present invention.

FIG. 5 is one example of a component list according to one embodiment of the present invention.

FIG. 6 is one example of an operation procedure sheet according to one embodiment of the present invention.

FIG. 7 is one example of an operation schedule according to one embodiment of the present invention.

FIG. 8 is a flow chart illustrating a process of deleting production drawing information at the time of completing production according to one embodiment of the present invention.

FIGS. 9A and 9B are a flow chart illustrating a preparation process of a service manual according to one embodiment of the present invention.

FIG. 10 is one example of a preparation screen of a service manual body according to one embodiment of the present invention.

FIG. 11 is one example of a component list according to one embodiment of the present invention.

FIG. 12 is one example of first association information according to one embodiment of the present invention.

FIG. 13 is one example of second association information according to one embodiment of the present invention.

FIG. 14 is one example of a version number correspondence table according to one embodiment of the present invention.

FIG. 15 is a flowchart illustrating a general flow according to another embodiment of the present invention.

FIG. 16 is a flowchart illustrating a renewal process of production drawing information according to another embodiment of the present invention.

FIG. 17 is one example of production drawing information before and after changes according to another embodiment of the present invention.

FIG. 18 is one example of changed part information according to another embodiment of the present invention.

FIG. 19 is a flow chart illustrating a renewal process of a service manual according to another embodiment of the present invention.

FIG. 20 is a flow chart illustrating a process of a change notice according to another embodiment of the present invention.

FIG. 21 is one example of priority order information by the type of change according to another embodiment of the present invention.

### DESCRIPTION OF THE PREFERRED EMBODIMENTS

In the above mentioned patent document 1, since it is necessary to associate the assembling operation content of the manufacturing side with the disassembling operation content of the maintenance and repair service side beforehand, the technique of patent document 1 cannot efficiently prepare and renew operating procedure sheets. Further, on the maintenance and repair service side, in some cases jigs and tools which are not present in the assembling procedure of the manufacturing side are used, and there is a problem in which even with the technique of the above mentioned patent document 1, such association as expanded to the information required for the preparing and renewal of the service manuals is not available.

Hereinafter, explanation is given, with reference to drawings, of a service manual preparing and managing system, a service manual preparing method, a service manual preparing program, a service manual managing program, and a service manual managing program.

### One Embodiment

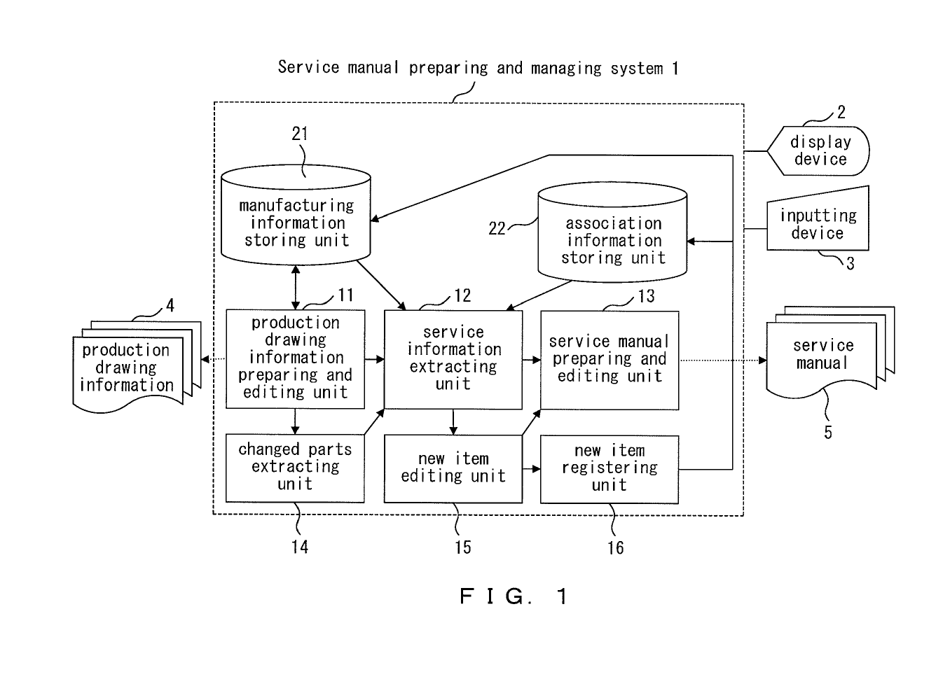

FIG. 1 is a skeleton framework illustrating a service manual preparing and managing system 1 according to one embodiment of the present invention.

As illustrated in FIG. 1, the service manual preparing and managing system 1 includes a production drawing information preparing and editing unit (one example of a production work information preparing and editing unit) 11, a service information extracting unit 12, a service manual preparing and editing unit 13, a changed parts extracting unit 14, a new item editing unit 15, a new item registering unit 16, a manufacturing information storing unit 21, and an association information storing unit 22. In addition, the service manual preparing and managing system 1 is connected to a display device 2 and an inputting device 3.

Described in detail later, the service manual preparing and managing system 1 prepares and manages a service manual 5 which is used for maintenance or repair of a product on the basis of the prepared production drawing information (production work information) 4, including product manufacturing information and an assembling procedure of the product.

The production drawing information preparing and editing unit 11 prepares, edits, and outputs the production drawing information 4 required for manufacturing products on the basis of the manufacturing information, which is the information of, for example, components, manufacturing processes, or the like recorded in the manufacturing information storing unit 21. The production drawing information 4 is registered, for example, in the manufacturing information storing unit 21.

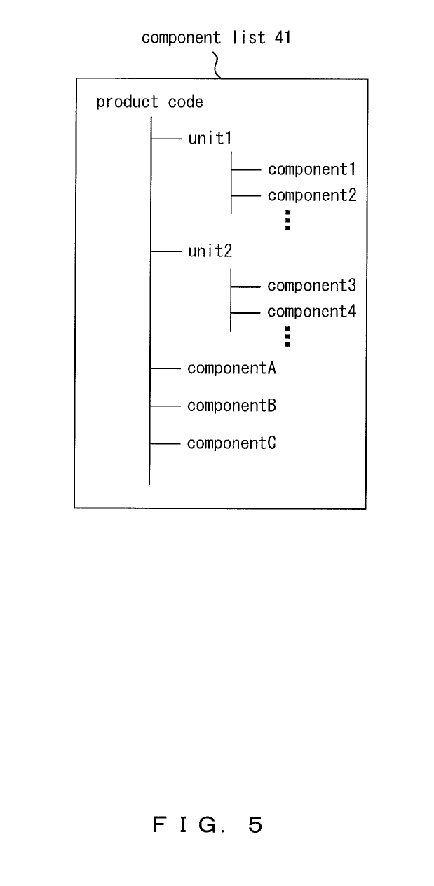

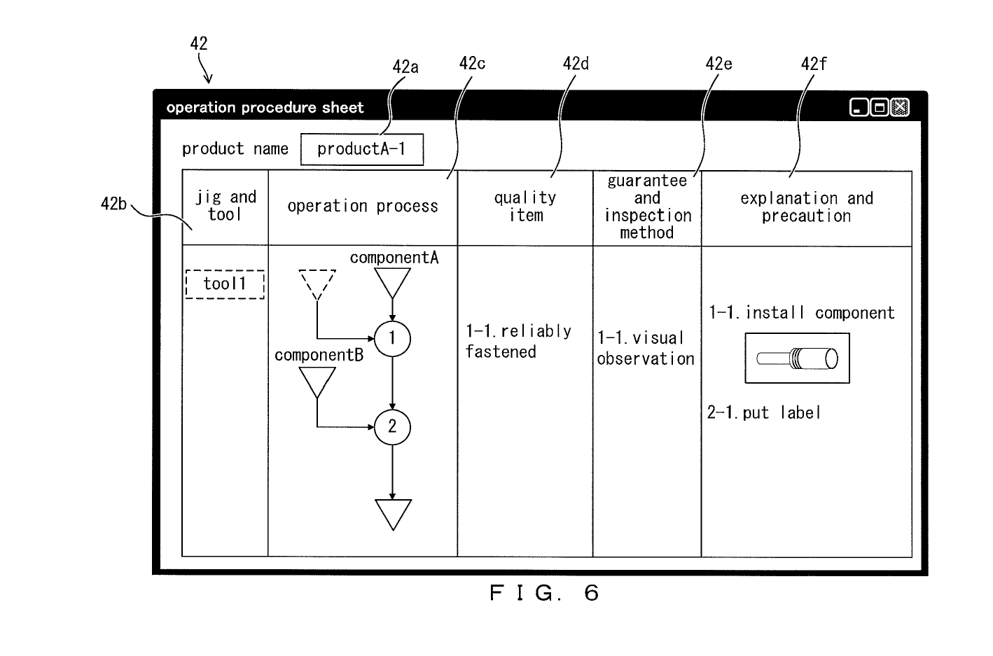

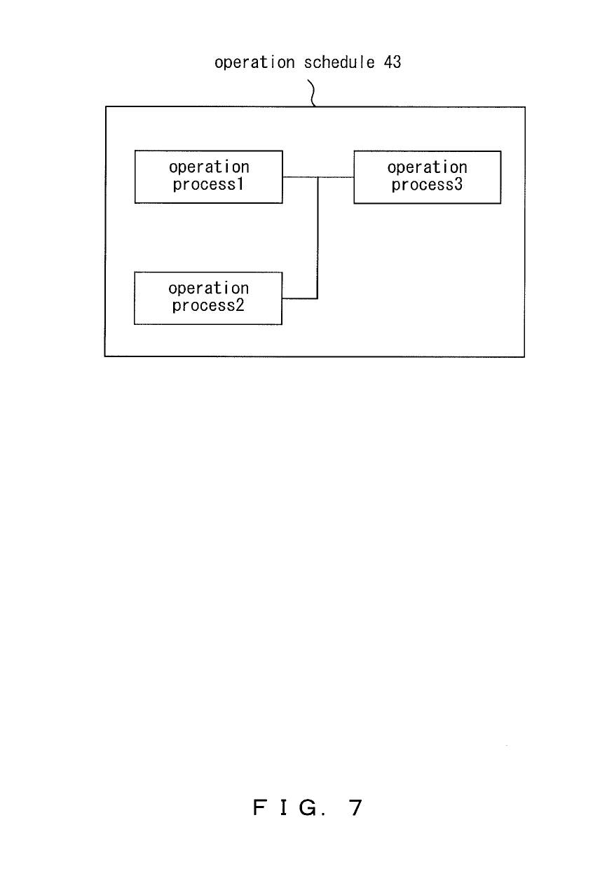

Production drawing information 4 includes a component list 41, an operation procedure sheet 42, and an operation schedule 43. The component list 41, as illustrated in FIG. 5, describes component structures used for product assembly. The operating procedure sheet 42, as illustrated in FIG. 6, describes steps of the assembly procedure on the basis of the process unit. And the operation schedule 43, as illustrated in FIG. 7, describes the assembly structure of the entire product associating the processes.

The component list 41 illustrated in FIG. 5 is illustrated in a hierarchized drawing format in which a product (product code) is composed of a unit 1, a unit 2, a component A, a component B, and a component C, etc., and the unit 1 is composed of the component 1, the component 2, etc., and the unit 2 is composed of the component 3, the component 4, etc.

The operating procedure sheet 42 illustrated in FIG. 6 includes, for example, a product name column (product A-1, etc.) 42a, a jig and tool column (tool 1, etc.) 42b, an operation process column (processing a component A by a process 1, and processing a process 2 with a component B, etc.) 42c, a quality item column (reliably fastened, etc.) 42d, a guarantee and inspection method (visual observation, etc.) 42e, and an explanation and precaution column (texts or drawings such as “install component” and “affix label”, etc.) 42f.

The operation schedule 43 illustrated in FIG. 7 is made by connecting blocks of each process in chronological order.

Production drawing information 4 is one example of production work information which is prepared including manufacturing information and assembling procedures and which is used by workers. In the present embodiment, the production drawing information 4 is illustrated by drawings.

An association information storing unit 22 stores association information which associates manufacturing information with service information. This service information includes, for example, information related to disassembling procedures, jigs and tools, etc., required for maintenance and repair services.

At the time of preparing the service manual 5, a service information extracting unit 12 extracts service information corresponding to production drawing information 4, which becomes the reference source of the service manual 5 from the association information storing unit 22, via the manufacturing information of the production drawing information 4 in order to add the service information to the service manual 5.

A service manual preparing and editing unit 13 prepares and edits a service manual 5 by using production drawing information 4 and service information corresponding to this production drawing information 4 and extracted by a service information extracting unit 12.

For example, a service manual preparing and editing unit 13 outputs a service manual 5 by editing disassembling and assembling procedures (production work information 4) for the service manual 5 and by embedding them in the format for the service manual 5.

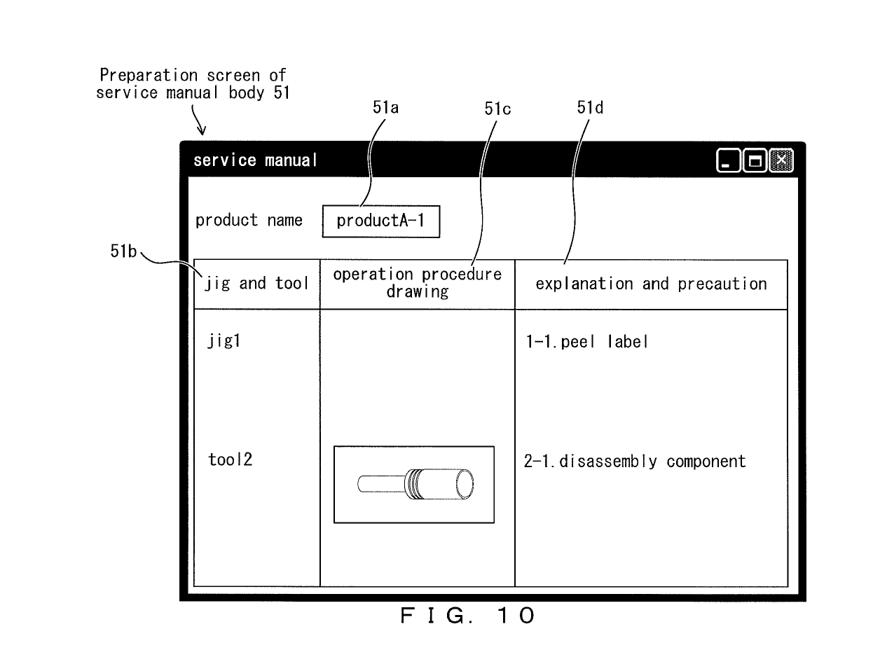

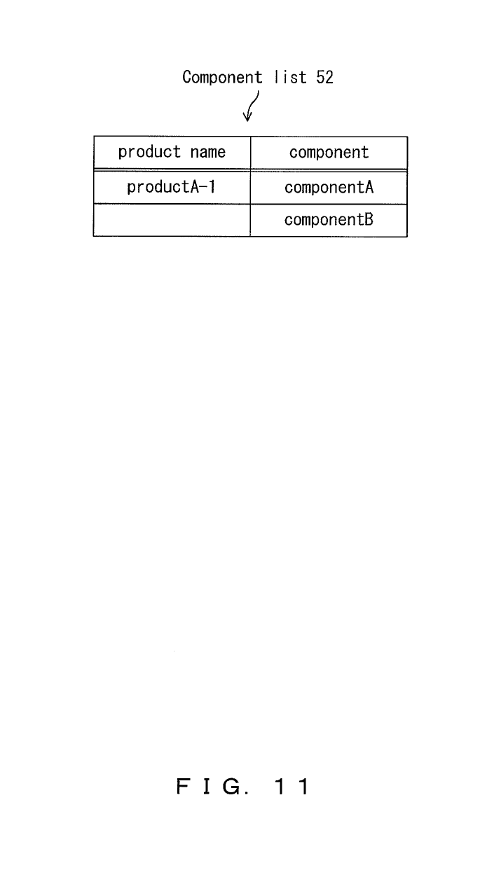

The service manual 5 includes a service manual body 51 prepared as illustrated in FIG. 10 and describing the procedures of providing a repair service for products, and a component list 52 describing components receiving services, as illustrated in FIG. 11.

A preparation screen of the service manual body 51 illustrated in FIG. 10, for example, includes, for example, a product name column (product A-1, etc.) 51a, a jig and tool column (jig 1, tool 2, etc.) 51b, a work drawing column 51c, and an explanation and precaution column (text, etc. such as “peel label”, “disassemble component”, etc.) 51d.

A component list 52 illustrated in FIG. 11 is the list which shows the product name (product A-1, etc.) and components which make up such a product (component A, component B, etc.).

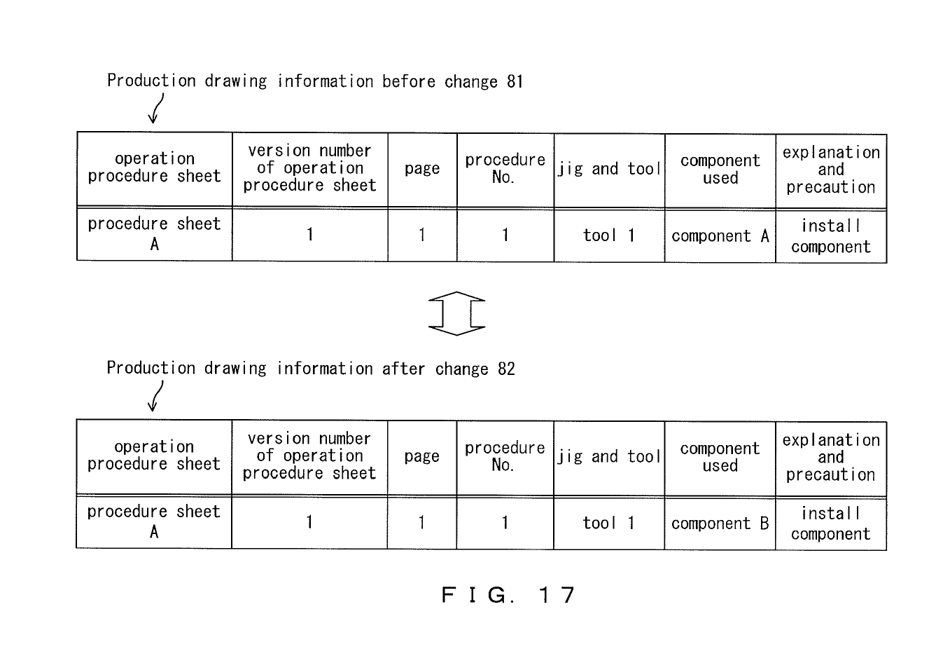

A changed parts extracting unit 14 extracts the changed parts information of production drawing information 4 when a change occurs in the production drawing information 4. Described later in the “other embodiments”, the changed parts extracting unit 14 compares the production drawing information 4 before and after changes with respect to the production drawing information 81 before the changes and the production drawing information 82 after the changes, as illustrated in FIG. 17, and provides changed parts information 83, which is information about the changed parts only, to the user.

A new item editing unit 15 edits new items, including, for example, the addition or the like of new items newly required which are not registered in the production information storing unit 21 or the association information storing unit 22, via an operation performed by a user at the time of preparing and renewing the service manual. For information, new items are not limited to added items but include changed items.

A new item registering unit 16 registers at least association information of the new items edited by the new item editing unit 15 in the association information storing unit 22. In the present embodiment, the new item registering unit 16 also registers the manufacturing information of the new items in the manufacturing information storing unit 21 via an operation performed by a user.

Hereinafter, the preparing method, etc. of the service manual according to the present embodiment is explained.

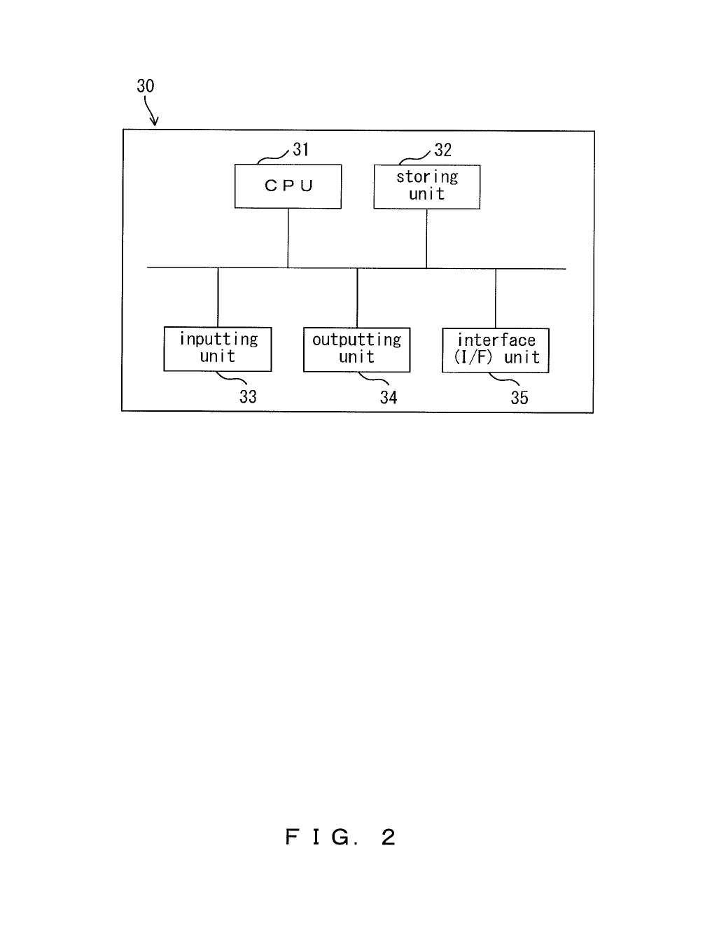

For the later-mentioned process, a computer having a standard structure, that is, a computer as illustrated in FIG. 2, an information processing terminal 30 including a CPU 31 (which corresponds to a production drawing information preparing and editing unit 11, a service information extracting unit 12, a service manual preparing and editing unit 13, a changed parts extracting unit 14, a new item editing unit 15, and a new item registering unit 16), a storing unit 32 (which corresponds to a manufacturing information storing unit 21 and an association information storing unit 22), an inputting unit 33 (which corresponds to an inputting device 3), an outputting unit 34, and an I/F (interface) unit 35 can be used.

Further, the CPU 31 controls each component by executing control programs. The storing unit 32 consists of ROM, RAM, a magnetic record medium, etc., and is used as storage of the control program which instructs the CPU 31 to control each component, or as a work area or a storage area of various types of data when the CPU 31 executes the control program. The inputting unit 33 acquires various kinds of data which correspond to an operation performed by the user. The outputting unit 34 notifies a user by providing various kinds of data on a display (which corresponds to the display device 2), etc. The I/F unit 35 provides interface functions for sending and receiving data with the other devices.

In addition, for instructing the information processing terminal 30 to execute a process of preparing (present embodiment) and managing (later-mentioned other embodiment) the service manual, it may be configured to prepare the control program for instructing the information processing terminal 30 to execute the later mentioned operation process (which corresponds to the service manual preparing program and the service manual managing program) to be stored in the computer-readable record medium so that the information processing terminal 30 may read the control program, for example from the record medium, for execution. As a result of this, the information processing terminal 30 functions as a service manual preparing and managing system 1 illustrated in FIG. 1.

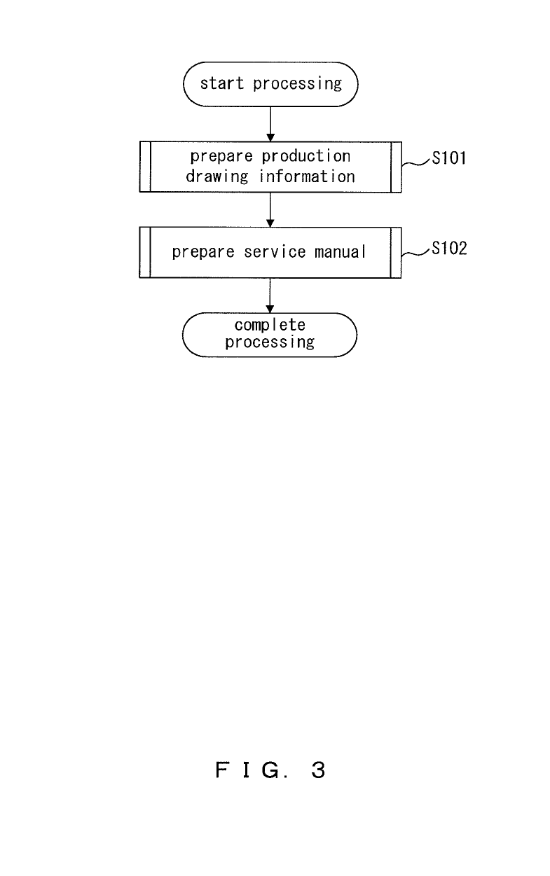

FIG. 3 is a flow chart illustrating a general flow of the present embodiment. The present embodiment, when roughly divided, includes the process of preparing the production drawing information 4 on the basis of the manufacturing information recorded in the manufacturing information storing unit 21 (step S101) and the process of preparing the service manual 5 by adding the service information on the basis of the production drawing information 4 (step S102).

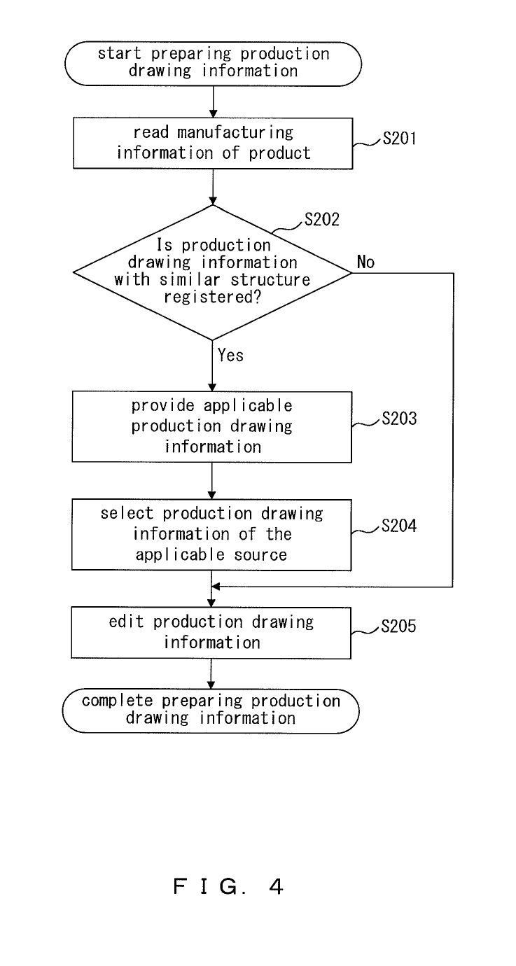

FIG. 4 is a flow chart illustrating a preparing process of production drawing information 4 of the present embodiment.

First, explanation is given for the process of preparing the production drawing information 4 on the basis of the manufacturing information by the production drawing information preparing and editing unit 11 using a flow of FIG. 4.

When the production drawing information 4 is prepared, the user selects the product code by the production drawing information preparing and editing unit 11 and reads the manufacturing information of the product from the manufacturing information storing unit 21 (step S201), and automatically judges whether the production drawing information 4 with a similar structure is registered in the manufacturing information storing unit 21 (step S202) by the production drawing information preparing and editing unit 11. For information, for example as to whether the production drawing information 4 with a similar structure is registered or not, it may be judged by an agreement rate of components or units which make up the product.

When the production drawing information 4 with a similar structure is registered, the production drawing information 4 is provided as preparation information of the past, which is the prior information (step S203). By selecting from the provided candidates, the user can newly prepare the production drawing information 4 by applying the already prepared production drawing information 4 (step S204). After application, the user edits the operation procedure using the production drawing information preparing and editing unit 11 and the production drawing information 4 is prepared (step S205).

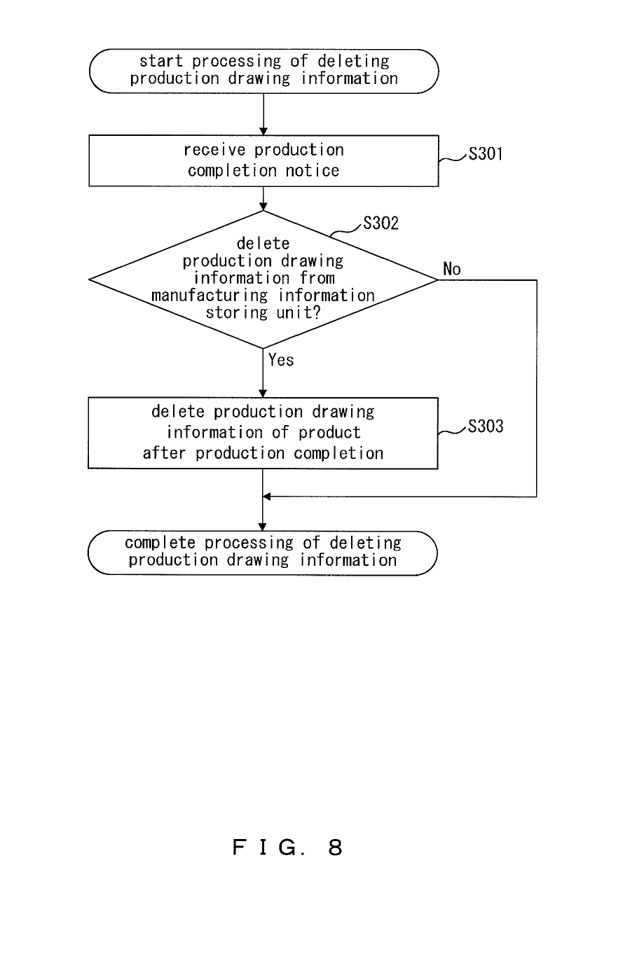

Next, the process of deleting the production drawing information 4 at the time of completing product production is explained using the flow of FIG. 8.

The product is manufactured on the basis of the prepared production drawing information, and in the production drawing information preparing and editing unit 11, for example, when the service manual preparing and managing system 1 receives the notice of completion of the production working together with the production managing information (step S301), etc., a configuration is made such that the user can judge whether to delete the production drawing information 4 of the product whose production is complete from the manufacturing information storing unit 21 (step S302) and can delete it (step S303). Regarding products that do not have any notices, it may be configured to be deleted at the discretion of the user.

Thus, the production drawing information 4 is deleted by the production drawing information preparing and editing unit 11 receiving the notice of completion of the product production and via an operation performed by the user. In this way, the increase in the data capacity of the manufacturing information storing unit 21 which stores the production drawing information 4 can be prevented and the manufacturing information can be quickly acquired when the production drawing information 4 is newly prepared and edited. Similarly, the increase in the data capacity can be prevented when the production drawing information 4 is registered in a different storing unit than the manufacturing information storing unit 21.

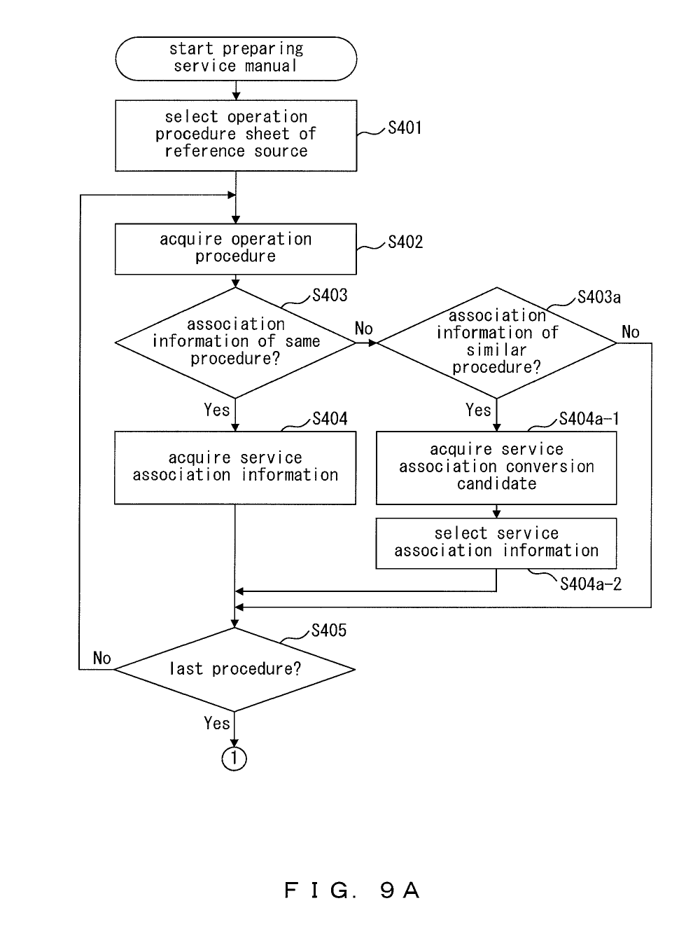

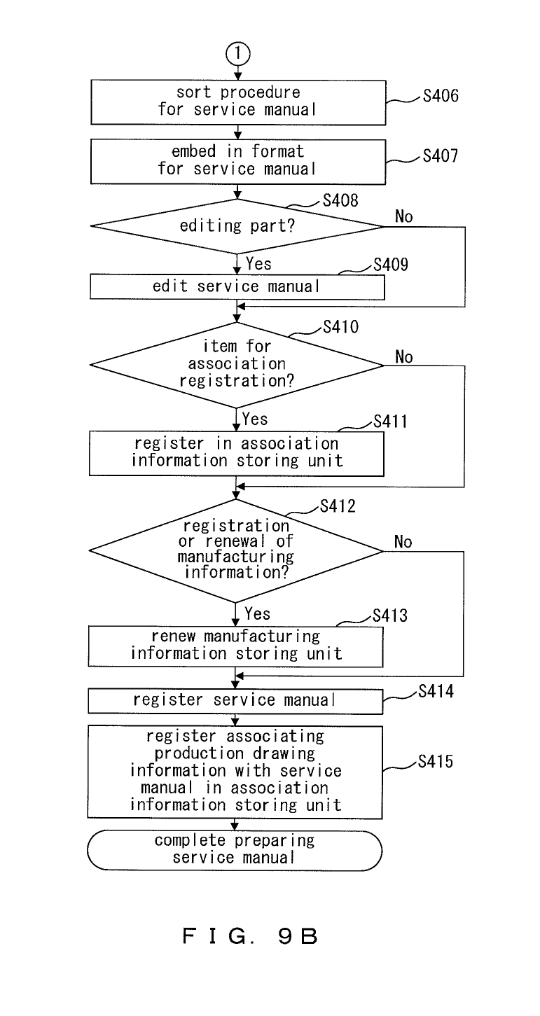

Next, the process of preparing the service manual 5 on the basis of the production drawing information 4 by the service information extracting unit 12 and the service manual preparing and editing unit 13 is explained using the flow of FIGS. 9A and 9B.

First, at the time of preparing the service manual, the user selects the operation procedure sheet 42 (work drawing information 4) that is the reference source of the service manual 5 prepared by the production drawing information preparing and editing unit 11 (step S401).

A service information extracting unit 12 acquires the work procedure information, which includes assembling procedures, jigs and tools to be used, etc., from the selected operation procedure sheet 42 (step S402), and performs judgment in which the result depends on whether the acquired work procedure information (manufacturing information) is registered in the association information storing unit 22 associated with the service information for preparing the service manual.

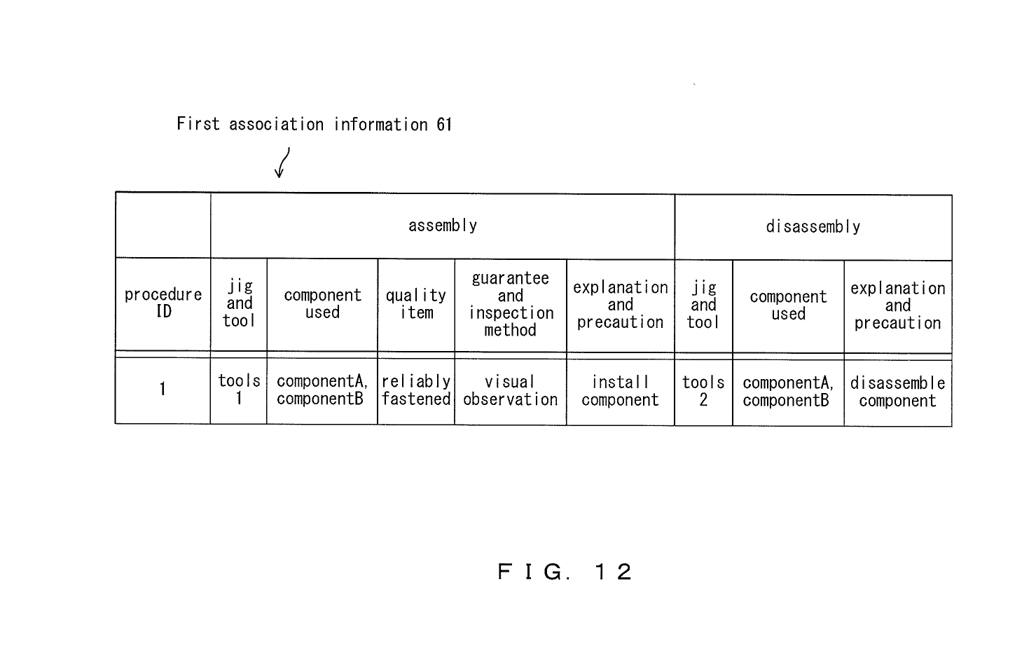

When association information of the same procedure (conformed work information) (in the example of FIG. 12, the procedure in which all of the items, i.e., jigs and tools, components to be used, quality item guarantees and inspection methods, and explanations and precautions are made to conform) is registered in a table of first association information 61 (in the example of FIG. 12, information on only one procedure) in which a detailed procedure is extracted (step S404) such as first association information 61 illustrated in FIG. 12 (step S403), the associated disassembling procedure or the information on jigs and tools, etc. required for the repair service (in the example of FIG. 12, information on jigs and tools, components to be used, and explanations and precautions).

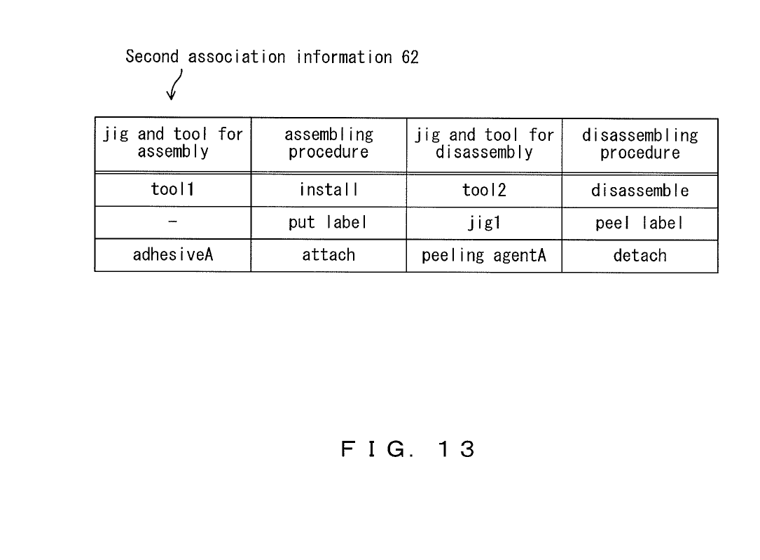

When the same procedure is not registered but there are the same assembling jigs and tools present in a table of second association information 62 with which keywords (work content and jigs and tools which correspond to the work content) such as those illustrated in FIG. 13 are associated, or when there is an assembling procedure present which partially conforms with the explanations and precautions, etc., in the first association information 61 illustrated in FIG. 12 (step S403a), a configuration is made to judge that a similar procedure (similar manufacturing information) is registered in association information and extract candidates of associated disassembling procedure information (step S404a-1), and to allow the user to apply it to the service manual 5 by selecting it (step S404a-2).

By extracting the information required for a repair service to all of the assembling procedures (step S405), by preparing the disassembling procedure that is shifting from the assembling procedure by the action of the service manual preparing and editing unit 13 (step S406), and by embedding the disassembling procedure and the assembling procedure after disassembly in the format for the service manual, the format is changed to that of a preparation screen of the service manual body 51, as illustrated in FIG. 10 (step S407).

The format of the preparation screen of the service manual body 51 of FIG. 10 is an example, and by reading the format information defined by the XML format, any format can be expressed.

When there is no association information present, or when editing of the service manual 5 such as for the addition of jigs and tools for the maintenance and repair service, making a change in a procedural step, etc. is required (step S408), the new item is edited for the repair service by the user in the new item editing unit 15 and the service manual 5 is prepared by the service manual preparing and editing unit 13 (step S409). Thus, the service manual preparing and editing unit 13 automatically generates the service manual using the production drawing information 4, the service information corresponding to this production drawing information 4 and extracted by the service information extracting unit 12, and the service information of the new item edited by the new item editing unit 15.

In addition, the service manual preparing and editing unit 13 provides the preparation information of the past to a user as prior information at the time of preparing the service manual 5, and the user can perform preparation by applying the already existing service manual 5 in the preparing and editing screen of the service manual 5.

When the new item is edited, a new item registering unit 16 urges determination of approval/denial of registration by providing information on whether or not the second association information 62 or jigs and tools should be registered, as illustrated in FIG. 13, in the new item to the user to the association information storing unit 22 (step S410). And when necessary, registration is performed (step S411).

Further, at the time of preparing the service manual 5, for example, the user judges whether or not the manufacturing information is affected (step S412), and when a change occurs in the manufacturing information, the manufacturing information storing unit 21 is renewed (step S413).

For example, at the time of editing the service manual 5, the service manual 5 is edited with reference to the operation procedure sheet 42 illustrated in FIG. 6, which is the reference source; however, when a clerical error is found in the operation procedure sheet 42 or when a decision is made to change the assembling procedure, a configuration is made such that, upon correction on the screen of the operation procedure sheet 42, the manufacturing side is notified of the correct content and the manufacturing side can confirm the corrected content and renew it in the production drawing information preparing and editing unit 11 of the manufacturing side.

The service manual preparing and editing unit 13, when the preparing of the service manual 5 is completed and registered (step S414), associates the production drawing information 4 (manufacturing information), which is the reference source, and the prepared service manual 5 in the association information storing unit 22, and, for example, records them, as illustrated as the first association information 61 of FIG. 12 (step S415).

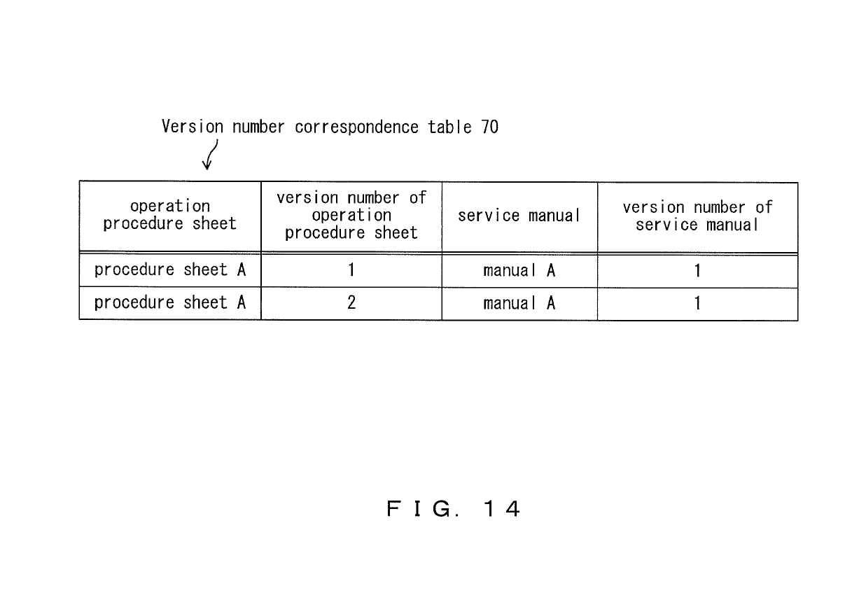

At this time, the service manual preparing and editing unit 13, as illustrated in FIG. 14, registers the version number correspondence table 70 (history information), which makes the version number of the service manual 5 correspond to the version number of the operation procedure sheet 41 (production drawing information 4) used in the preparation of this service manual 5 in, for example, the association information storing unit 22.

In the present embodiment explained so far above, the service information extracting unit 12 extracts the service information which corresponds to the production drawing information (production work information) 4 on the basis of the association information which associates the manufacturing information with the service information required for the maintenance or repair of the product. The service manual preparing and editing unit 13 prepares the service manual 5 using the production work information and the extracted service information, and at least the association information of the new item of the service manual 5 edited via an operation performed by the user at the time of preparing the service manual 5 is registered in the association information storing unit 22 by the new item registering unit 16.

Accordingly, the items required for the maintenance and repair service side, including, for example, jig and tool information which is not present in the assembling procedure of the manufacturing side, can be registered by associating them with the manufacturing information at the time of preparing the service manual, which facilitates the preparing and renewal of the service manual. Therefore, according to the present embodiment, the service manual 5 can be efficiently prepared and renewed.

In addition, in the present embodiment, the service manual preparing and managing system 1 prepares the production drawing information 4 from the manufacturing information as well as includes the production drawing information preparing and editing unit 11 for editing. Therefore, the service manual 5 can be prepared more efficiently.

Further, in the present embodiment, the production drawing information preparing and editing unit 11 and the service manual preparing and editing unit 13 provide the preparation information of the past to the user as prior information at the time of preparation. Therefore, the service manual 5 can be prepared more efficiently.

Moreover, in the present embodiment, the production drawing information preparing and editing unit 11 deletes the production drawing information 4 by receiving the notice of completion of the product production and via an operation performed by the user. Therefore, an increase in the data capacity can be prevented and information can be acquired rapidly, and the service manual 5 can be prepared more efficiently.

Moreover, in the present embodiment, the service information extracting unit 12 extracts the service information associated with the manufacturing information which conforms with the production drawing information 4 on the basis of the association information, and when such service information cannot be extracted, the service information associated with the manufacturing information that is similar to the production drawing information 4 is extracted. Therefore, the service manual 5 can be prepared more efficiently.

In the present embodiment, the new item registering unit 16 urges the determination of approval/denial of registration by providing at least the association information of the new item to the user. Thereby, the service manual 5 can be prepared more efficiently.

Also in the present embodiment, the service manual preparing and editing unit 13 automatically generates the service manual 5 using the production drawing information 4, the service information corresponding to this production drawing information 4 and extracted by the service information extracting unit 12, and the service information of the new item edited by the new item editing unit 15, and also edits the service manual 5 via an operation performed by the user. Thereby, the service manual 5 can be prepared more efficiently.

Moreover, in the present embodiment, the service manual preparing and editing unit 13 registers the information (version number correspondence table 70 of FIG. 14, which is history information) which makes the version number of the service manual 5 correspond to the production drawing information 4 used at the time of preparing this service manual 5.

Further, although in the present embodiment the service manual preparing and managing system 1 includes the production drawing information preparing and editing unit 11, the production drawing information 4 may be acquired from the other systems or the like.

### Another Embodiment

In the present embodiment, a service manual managing method and a managing program are explained. However, since the service manual preparing and managing system 1 according to one embodiment as mentioned above can be used, the explanation of the matter commonly shared by the above mentioned embodiment is abbreviated. In addition, other than renewal of the service manual, the service manual management includes, for example, outputting, addition, deletion, etc.

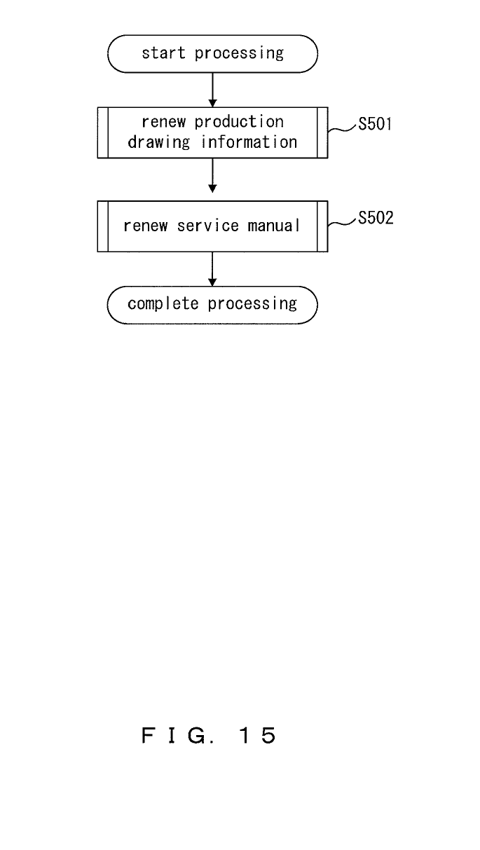

FIG. 15 is a flowchart illustrating a general flow of the present embodiment.

The present embodiment, when roughly divided, includes the process of renewing the production drawing information 4 (step S501) and the process of renewing the service manual 5 on the basis of the changed parts information of the production drawing information 4 (step S502).

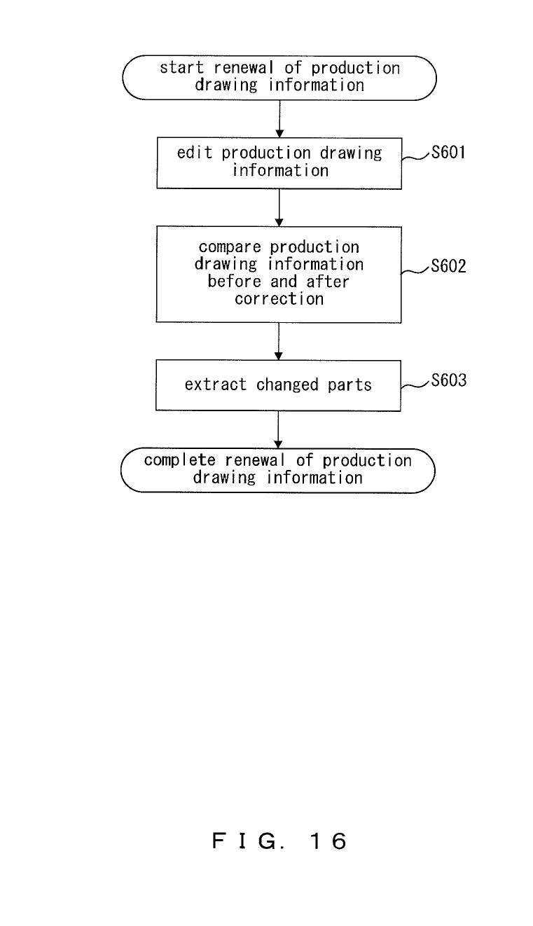

First, explanation is given for the process of editing the production drawing information 4 and outputting the changed parts information using a flow of FIG. 16.

When a change occurs in the assembling procedure of the product, etc., the user edits the production drawing information 4 by the production drawing preparing and editing unit 11 and outputs the production drawing information 4 with the corrected content reflected thereon (step S601).

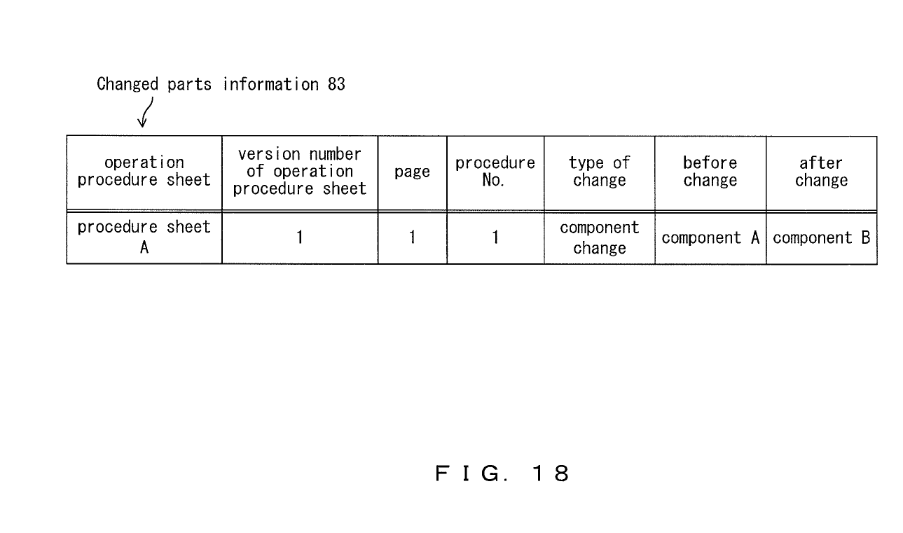

At the same time, as illustrated in FIG. 17, the changed parts extracting unit 14 compares the production drawing information 81 before a change and the production drawing information 82 after a change (step S602), and when there are any different parts, performs extraction as changed parts information 83 illustrated in FIG. 18 (step S603) and outputs the changed parts information 83 illustrated in FIG. 18 as change notice information by judging the types of change from the changed content registered in the manufacturing information storing unit 21 beforehand from the changed parts and the association information of the types of changes.

For information, the production drawing information 81 and 82 illustrated in FIG. 17 is one example which shows information on an operation procedure sheet, a version number, a page, a procedure number, a jig and tool, a component to be used, and explanations and precautions regarding the changed parts. In the example of FIG. 17, the component to be used is changed from a component A to a component B.

Further, the changed parts information illustrated in FIG. 18 is one example which shows information on a type of change (change of components), the state before a change (component A), and the state after a change (component B), as well as the information on an operation procedure sheet, a version number, a page, and a procedure number.

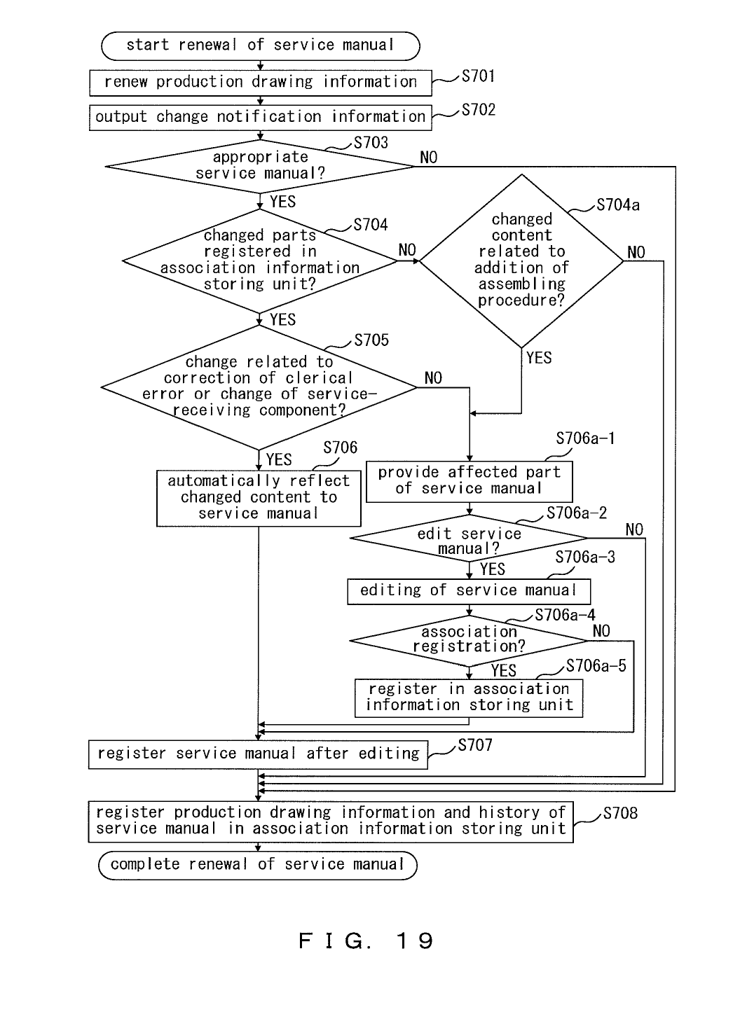

Next, explanation is given for the process of reflecting the change in the service manual 5 when a change occurs in the production drawing information 4 using a flow of FIG. 19.

When a change occurs in the production drawing information 4 (step S701), the changed parts extracting unit 14 outputs the change notice information (changed parts information 83) as illustrated in FIG. 18 (step S702). The service information extracting unit 12 judges whether there are any service manuals present which refers to the changed production drawing information, on the basis of the version number correspondence table 70 illustrated in FIG. 14 (step S703).

When there is a service manual present, the service manual preparing and editing unit 13 further judges whether the service manual 5 is affected on the basis of the change notice information and association information (step S704). When the type of change of the change notice information (changed parts information 83) illustrated in FIG. 18 is “correction of clerical errors” or when the type of change is “change of components” and the component before the change is the change in the service-receiving component registered in the component information of the association information storing unit (step S705), the service manual preparing and editing unit 13 automatically converts the changed parts of the service manual 5 (step S706).

When the changed content is the addition of the procedure (step S704a), the service manual 5 whose reference source is the operation procedure sheet 41 (production drawing information 4) with the added procedure is extracted from the version number correspondence table 70 of FIG. 14 to provide the affected parts, and the display urges the user to correct the service manual 5 (step S706a-1).

When correction is required for the service manual 5 (step S706a-2), the user performs editing, including additions to and changes in the new item implemented by the new item editing unit 15 via manual conversion and reflects these in the service manual 5 via the service manual preparing and editing unit 13 (step S706a-3). At the same time, the user judges whether to register the changes in the association information storing unit 22 (step S706a-4), and when necessary, the new item registering unit 16 performs registration (step S706a-5).

In addition, when newly added item or edited item occur in the service manual 5, the service manual 5 is prepared with the service information added by the new item editing unit 15 and when registration is required for association information storing unit 22, it is preferable to register it depending on the user's judgment by the new item registering unit 16.

When the change is reflected in the service manual 5 (step S707), the history information of the service manual 5 after a change is registered, for example, in the association information storing unit 22, similarly to the version number correspondence table 70 illustrated in FIG. 14, associating the history of the production drawing information 4 after a change in the association information storing unit 21 (step S708). Even when no change in the service manual 5 is required, it is preferable to register it associating it with the history of the production drawing information 4 after a change.

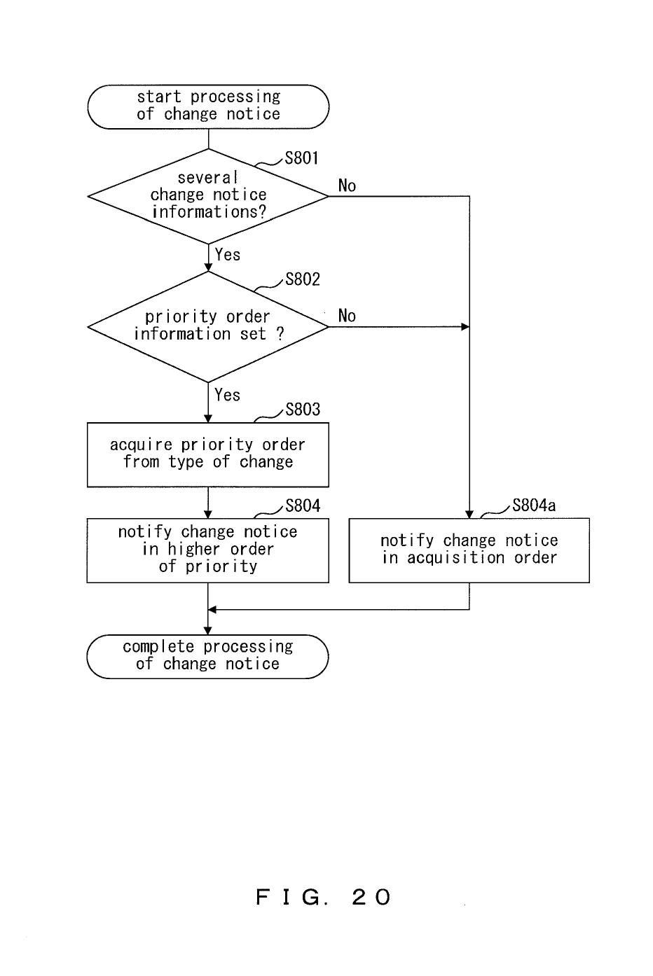

Next, explanation is given for the process of reflecting several pieces of change notice information using a flow of FIG. 20.

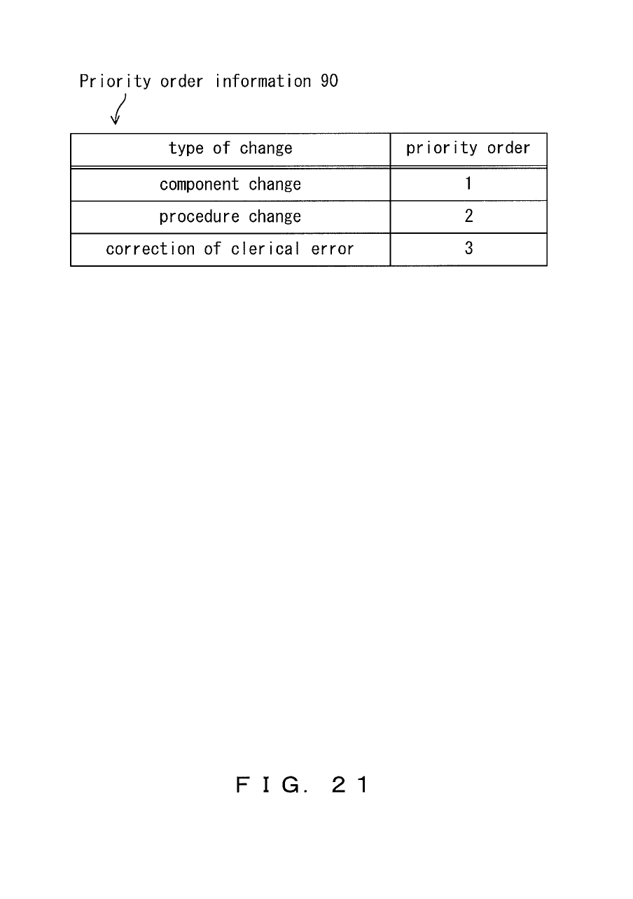

When the above mentioned change notice information (changed parts information 83 illustrated in FIG. 18) is output, the changed parts extracting unit 14 judges whether there are several pieces of change notice information (step S801), and if there are several pieces of information, it judges whether the priority order information 90 of the type of change is set in the manufacturing information storing unit 21 beforehand, as illustrated in FIG. 21 (step S802).

When the priority order information is set, priority order (in FIG. 21, priority order 1) is judged from the type of change of the change notice information (in FIG. 18, change of components) and the priority order is added to the change notice information (step S803). On the basis of the priority order information added to the change notice information, the user is provided with effect judgment for the service manual 5 and its affected parts by the change notice at a higher priority order so that the changed content may be reflected (step S804). When the priority order is not set, the user is provided with an effect judgment for the service manual 5 and its affected parts by the acquired change notice so that the changed content may be reflected (step S804a).

In the present embodiment, as explained so far, at least the association information of the new item of the service manual 5 edited via an operation performed by the user at the time of renewal of the service manual 5 is registered in the association information storing unit 22. Therefore, the items required for the maintenance and repair service side, such as jig and tool information, etc., which are not present in the assembling procedure of the manufacturing side can be registered as associated with the manufacturing information at the time of renewal of the service manual, which facilitates preparing and renewal of the service manual. Therefore, according to the present embodiment, the service manual 5 can be efficiently prepared and renewed.

In addition, in the present embodiment, the changed parts extracting unit 14, when a change occurs in the production drawing information 4, extracts changed parts information 83, and the service manual preparing and editing unit 13 edits the service manual 5 on the basis of the extracted changed parts information 83. Therefore, the service manual 5 can be renewed more efficiently.

In addition, in the present embodiment, when there are several pieces of changed parts information 83 present, a changed parts extracting unit 14 provides to the user the adding of the preliminarily registered priority order information 90 to these pieces of changed parts information. Therefore, the service manual 5 can be renewed more efficiently.

Further, in the present embodiment, the changed parts extracting unit 14 compares the production drawing information 4 before and after changes and provides the extracted changed parts information 83 to the user. Thereby, the service manual 5 can be renewed more efficiently.

In addition, in the present embodiment, although explanation is given for the renewal of the service manual 5 (S706, S706a-1 to S708) in relation to the renewal of the production drawing information 4 (S701), when the production drawing information 4 is not renewed, it may also be configured to perform renewal, etc., of the service manual 5 (S706a-1 to S708) of the user.

What is claimed is:

1. A service manual preparing and managing system for preparing and managing a service manual used for maintenance or repair of a product on the basis of production work information that has been prepared, including manufacturing information and an assembling procedure of the product, the service manual preparing and managing system comprising:
an association information storing unit which stores association information associating the manufacturing information with service information required for maintenance or repair of the product;
a service information extracting unit which extracts the service information corresponding to the production work information on the basis of the association information;
a service manual preparing and editing unit which prepares the service manual as well as edits said service manual using the production work information and the service information corresponding to said production work information and extracted by the service information extracting unit;
a new item editing unit which edits a new item of the service manual via an operation performed by a user at the time of preparing and renewing the service manual; and
a new item registering unit which registers at least the association information of the new item edited by the new item editing unit in the association information storing unit.

2. The service manual preparing and managing system according to claim 1, further comprising
a production work information preparing and editing unit which prepares as well as edits the production work information from the manufacturing information.

3. The service manual preparing and managing system according to claim 2, Wherein
the production work information preparing and editing unit and the service manual preparing and editing unit provide preparation information of the past as prior information to a user at the time of preparation.

4. The service manual preparing and managing system according to claim 2, wherein
the production work information preparing and editing unit deletes the production work information via receipt of a notice informing of the production completion of the product and via an operation performed by a user.

5. The service manual preparing and managing system according to claim 1, wherein
the service information extracting unit extracts, on the basis of the association information, the service information associated with the manufacturing information which conforms with the production work information, and when said service information cannot be extracted, extracts the service information associated with the manufacturing information, similarly to the production work information.

6. The service manual preparing and managing system according to claim 1, wherein
the new item registering unit urges determination of the validity/invalidity of a registration by providing at least the association information of the new item to a user.

7. The service manual preparing and managing system according to claim 1, wherein
the service manual preparing and editing unit automatically generates the service manual using the production work information, the service information corresponding to said production work information and extracted by the service information extracting unit, and the service information of the new item edited by the new item editing unit, as well as edits the service manual via an operation performed by a user.

8. The service manual preparing and managing system according to claim 1, wherein
the service manual preparing and editing unit registers information which makes a version number of the service manual correspond to the production work information used at the time of preparing said service manual.

9. The service manual preparing and managing system according to claim 1, further comprising
a changed parts extracting unit which extracts changed parts information of the production work information when a change occurs in said production work information, wherein
and the service manual preparing and editing unit edits the service manual on the basis of the changed parts information.

10. The service manual preparing and managing system according to claim 9, wherein
when there are several pieces of changed parts information present, the changed parts extracting unit provides to a user an adding of preliminarily registered priority order information to said several pieces of changed parts information.

11. The service manual preparing and managing system according to claim 9, wherein
the changed parts extracting unit compares production work information before and after changes and provides the extracted changed parts information to a user.

12. A method for preparing a service manual using a computer, the service manual being used for maintenance or repair of a product on the basis of production work information that has been prepared, including production information and an assembling procedure of the product, the method comprising:
extracting, on the basis of association information which associates the manufacturing information with service information required for maintenance or repair of the product, the service information which corresponds to the production work information, using the computer;
preparing the service manual using the production work information and the service information corresponding to said production work information and extracted by the service information extracting unit, using the computer; and
registering at least the association information of a new item of the service manual edited via an operation performed by a user at the time of preparing the service manual using the computer.

13. A record medium storing a service manual preparing program for causing a computer to execute a process for preparing a service manual used for maintenance or repair of a product on the basis of production work information that has been prepared, including manufacturing information and an assembling procedure of the product, the process comprising:
extracting, on the basis of association information which associates the manufacturing information with service information required for maintenance or repair of the product, the service information which corresponds to the production work information;
preparing the service manual using the production work information and the service information which corresponds to the production work information and is extracted by the service information extracting unit; and
registering at least the association information of a new item of the service manual edited via an operation performed by a user at the time of preparing the service manual.

14. A method for managing a service manual using a computer, the service manual being used for maintenance or repair of a product on the basis of production work information that has been prepared, including production information and an assembling procedure of the product, the method comprising;
registering at least the association information of anew item of the service manual edited via an operation performed by a user at the time of renewing the service manual using the computer.

15. The method for preparing and managing a service manual according to claim 14, the method comprising:
when a change occurs in the production work information, extracting changed parts information of said production work information using the computer, and
on the basis of the changed parts information of the extracted production work information, editing the service manual using the computer.

16. A record medium storing a service manual managing program for causing a computer to execute a process for managing a service manual used for maintenance or repair of a product on the basis of production work information that has been prepared, including manufacturing information and an assembling procedure of the product, the process comprising
registering at least the association information of a new item of the service manual edited via an operation performed by a user at the time of renewing the service manual.

17. The record medium according to claim 16, wherein the process further comprising:
extracting changed parts information of said production work information when a change occurs in the production work information, and
editing the service manual on the basis of the changed parts information of the extracted production work information.
